(19) United States
(12) Patent Application Publication
(10) Pub. No.: US 2024/0269033 A1
(43) Pub. Date: Aug. 15, 2024

(54) ARTIFICIAL PENIS FOR FEMALE GENITAL ORGAN

(71) Applicant: Derek Genoud, Arbaz (CH)

(72) Inventor: Derek Genoud, Arbaz (CH)

(21) Appl. No.: 18/567,637

(22) PCT Filed: Jun. 9, 2022
(86) PCT No.: PCT/EP2022/065765

§ 371 Date: Dec. 6, 2023

(30) Foreign Application Priority Data
Jun. 9, 2021 (FR) FR2106080

(51) Int. Cl. A61H 19/00

(52) U.S. Cl. CPC A61H 19/34; A61H 19/44; A61H 19/50; A61H 2201/0103; A61H 2201/1215; A61H 2201/163; A61H 2201/5007; A61H 2201/5084

(57) ABSTRACT

The invention relates to an artificial penis for female genital organ, comprising:
a phallic-shaped body (1) made of a chosen material,
a contact module (3); and
a clitoral stimulation module (4), arranged in a selected position relative to the contact module (3), and configured to perform an action enabling stimulation of the wearer's clitoris; the prosthesis furthermore comprises:
means for detecting movement (40) of said prosthesis during use, connected to the clitoral stimulation module (4), and configured to detect the movements made by the prosthesis according to selected parameters; and
processing means (50), connected to the means for detecting movement and clitoral stimulation module (4), configured to vary the intensity of clitoral stimulation in proportion to the frequency and/or amplitude of movement detected by the prosthesis.

The present invention concerns a penile prosthesis for female genital organ.

The invention relates more specifically to the simultaneous stimulation of the female genital organ of the prosthesis wearer in combination with stimulation of the receiver of the prosthesis.

Penile prosthesis refers in this case to a phallic-shaped structure configured to be worn by a wearer and capable of allowing penetration of a partner.

### PRIOR ART

On the one hand, devices are known for clitoral stimulation by massage, vibration or pulsed air. These devices are designed for manual use by the user and only allow a single user to be stimulated.

Neither do these devices provide adequate, realistic and satisfactory clitoral stimulation of the wearer unless the device is held in the user's hand.

These devices for clitoral stimulation by massage, vibration or pulsed air include means of varying the clitoral stimulation by remote control or by pressing a control button.

The disadvantage of these means of varying clitoral stimulation is that the user has to adjust the stimulation intensity manually.

On the other hand, prosthesis-type devices are known that enable the wearer's partner to be penetrated. These devices sometimes feature clitoral stimulation of the wearer by vibration or massage.

These prosthesis-type devices have the main disadvantage of not providing satisfactory clitoral stimulation for the wearer, as the stimulation zone of these devices is subject to movements that periodically move the stimulation module away from the wearer's erogenous zone to be stimulated.

These prosthesis-type devices are essentially designed to penetrate the wearer's partner. Their main function is to enable penetration of the user's partner or to provide light stimulation by vibration or rubbing against the wearer.

In general, these prosthesis-type devices cannot effectively simulate a state of erection.

These devices are not easy to use either and may cause irritation to the user through the perspiration and rubbing movements during use.

The aim of the present invention is to overcome these drawbacks.

The invention relates to a penile prosthesis for the female genital organ
a phallic-shaped body made of a selected material,
a contact module arranged at one end of the body, configured to attach to and cover the user's genital organ and having a contact surface configured to be placed in contact with the user's pubic region and allow the prosthesis to be locked in its position of use on the user's genital organ; and
a clitoral stimulation module, arranged in a selected position relative to the contact module, and configured to perform an action enabling stimulation of the wearer's clitoris.

According to a general definition of the invention, the penile prosthesis comprises:
means for detecting movement of said prosthesis during use, connected to the clitoral stimulation module, and configured to detect the movements made by the prosthesis according to selected parameters; and
processing means, connected to the means for detecting movement and clitoral stimulation module, configured to vary the intensity of clitoral stimulation in proportion to the frequency and/or amplitude of movement detected.

Advantageously, the invention enables simultaneous stimulation of the prosthesis wearer's female genital organ in combination with stimulation of the partner receiving the prosthesis during a sexual act, with a level of stimulation of a variability depending on the movement and pressure exerted on said prosthesis, thus affording realistic stimulation for the wearer.

In practice, the means for detecting movement belong to the group of the accelerometer type, configured to measure the acceleration of said prosthesis during movement in use, and at least one on-board pressure sensor mounted on the body, configured to vary the clitoral stimulation in proportion to the pressure exerted on the body, of the accelerometer type in combination with at least one on-board pressure sensor mounted on the body.

According to a first embodiment of the invention, the accelerometer is of the non-servo-controlled type and belongs to the group formed by: piezoelectric detection, piezoresistive detection, strain gauge/extensometry, capacitive detection, inductive detection, optical detection, vibrating beam, surface wave.

In practice, the accelerometer detects movements along one to three orthogonal axes.

During use, the processing means control the variation in the intensity of clitoral stimulation applied by the clitoral stimulation module to the wearer's female genital organ, with the variation being proportional to the acceleration measured when the accelerometer detects at least one movement with a frequency above a chosen threshold.

In practice, the clitoral stimulation module furthermore comprises:
at least one power source;
an electrically powered motor;
at least one button for electrically activating/deactivating the stimulation module;
a vibrating membrane comprising an annular or approximately annular section forming a clitoral endpiece, capable of being applied around the clitoral area and in contact with the base of the erectile module, and a membrane forming a partition over the entire internal surface of the annular section, said membrane being configured to be moved back and forth repeatedly by the motor during use, and capable of creating a suction effect on the covered clitoral surface while allowing the transmission of vibrations from the erectile module to said covered clitoral area;
and configured to allow the user to define a maximum intensity threshold within which variations in the stimulation intensity are included.

In other words, variations in stimulation via the accelerometer will be limited to the intensity ranges selected by the user.

Advantageously, the user can configure the stimulation variation thresholds by selecting previously saved speed thresholds, a speed that is adaptable to movement and/or to pressure.

According to one particular embodiment of the invention, the prosthesis furthermore comprises:
an erectile module, comprising a structure forming the male genital organ and capable of moving from a state of rest to a state of erection, and from a state of erection to a state of rest, and comprising:
the phallic-shaped body made of a selected deformable material;
inflation means arranged along the length of the internal volume of the body, configured to receive at least one selected liquid from pumping means, and configured to allow the erectile module to move from a so-called state of rest to a state of erection and from a state of erection to a state of rest;
a testicular structure projecting from the base of the erectile module and comprising the pumping means;
the pumping means comprising a pumping reservoir adapted to contain at least one selected liquid, connected on the one hand to an elastic manual pump, and on the other hand to the inflation means, said pumping reservoir being configured to eject the liquid contained in the reservoir towards the inflation means when manual compression is applied to said pump; and
the elastic manual pump furthermore comprises at least one non-return valve arranged between said pump and the reservoir, configured to maintain the liquid ejected into the inflation means in the state of erection, said valve being furthermore configured to allow the return of the liquid from the inflation means to the pumping reservoir when compression is applied to said valve.

Advantageously, a penile prosthesis capable of reproducing the functional erectile properties of the male sex organ in a simple, safe and realistic manner, while allowing said prosthesis to be easily applied to the user.

According to one particular embodiment of the invention, the inflation means have an exoskeleton made of a selected deformable material arranged along the entire length of the inflation means and configured to stiffen the erectile module in a state of erection.

According to one particular embodiment of the invention, the clitoral stimulation module furthermore comprises:
at least one power source;
an electrically powered motor;
at least one button for electrically activating/deactivating the stimulation module;
a vibrating membrane comprising an annular or approximately annular section, capable of being applied around the clitoral area and in contact with the base of the erectile module, and a membrane forming a partition over the entire internal surface of the annular section, said membrane being configured to be moved back and forth repeatedly by the motor during use, and capable of creating a suction effect on the covered clitoral surface while allowing the transmission of vibrations from the erectile module to said covered clitoral area.

According to one particular embodiment of the invention, the contact module furthermore comprises a urine collection cup capable of collecting the product of urination during use, said cup being integrally connected to a urine evacuation duct incorporated in the erectile module, and running the length of said erectile module up to its distal end, and configured to allow the evacuation of urine from the collection cup, and towards the outside of the prosthesis in the state of rest and in the state of erection.

According to another embodiment of the invention, the inflation means arranged along the length of the internal volume of the body comprise at least two inflatable tubular structures arranged laterally and parallel to each other, and configured to be inflated simultaneously when moving from the state of rest to the state of erection.

In practice, the inflation means have an exoskeleton made of a selected deformable material arranged along the entire length of the inflation means and configured to stiffen the erectile module in a state of erection.

According to one particular embodiment of the invention, the lower section of the contact module comprises a penetrating instrument configured to allow vaginal or anal penetration of the wearer.

Surprisingly, the penile prosthesis according to the invention can be used continuously, without the need to remove it to urinate, and can be used to simulate realistic sexual stimulation during sexual intercourse, while the user can control the state of erection and state of rest of the prosthesis.

### BRIEF DESCRIPTION OF THE DRAWINGS

The invention will be better understood upon detailed study of a few embodiments considered by way of non-restrictive examples and illustrated by the appended drawings, in which:

FIG. 1 shows an outer view of the prosthesis according to the invention;

FIG. 2 shows a rear outer view of the prosthesis according to the invention;

FIG. 3 shows an exploded view of the internal components of the prosthesis according to the invention;

FIG. 4 schematically shows a rear exploded view of the electronic and mechanical internal components of the prosthesis according to the invention;

FIG. 5 shows a rear exploded view of the internal components of the prosthesis according to the invention;

FIG. 6 shows a cross-sectional view along view of the prosthesis according to the invention; and

FIG. 7 shows an assembled view of the erectile module of the prosthesis according to the invention.

### DETAILED DESCRIPTION OF THE FIGURES

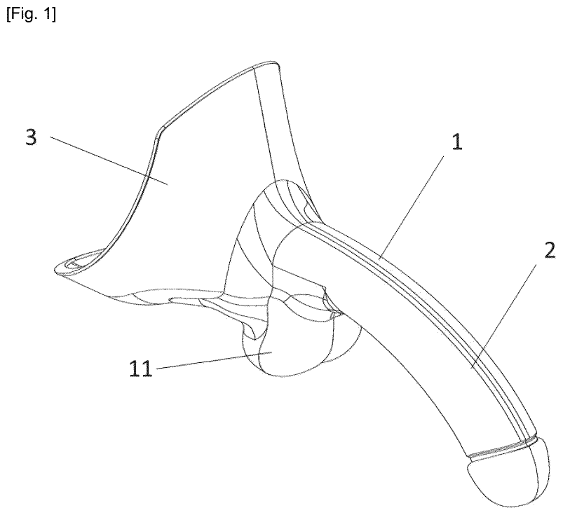

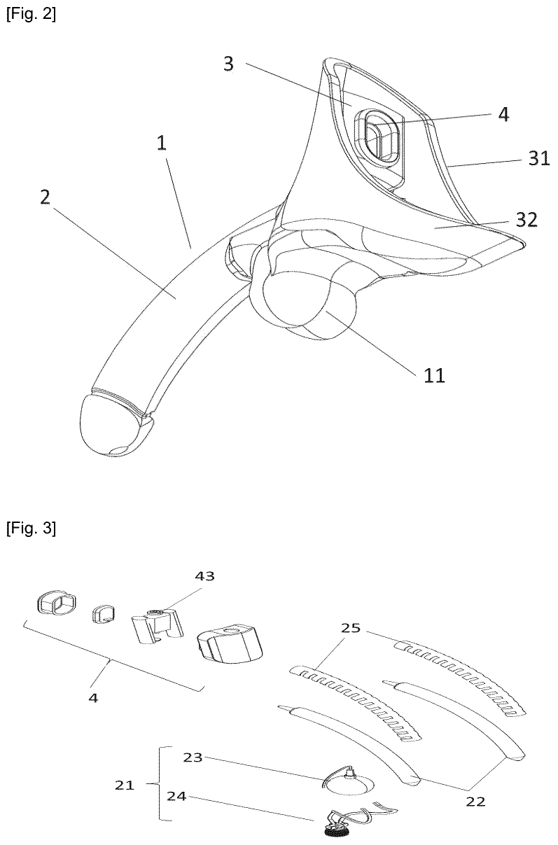

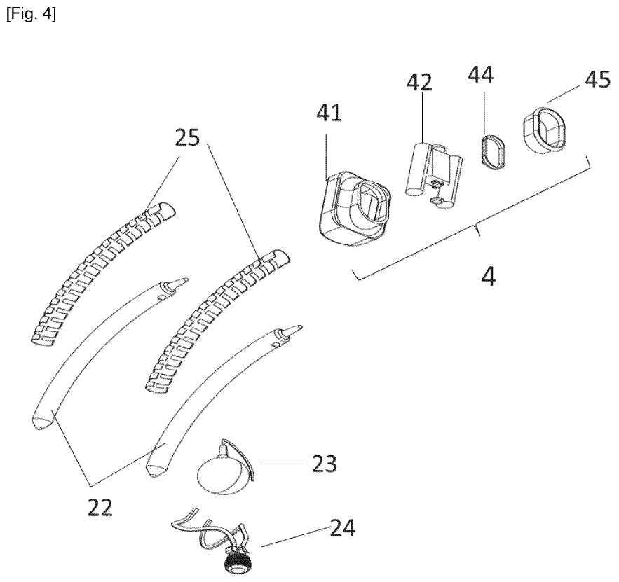

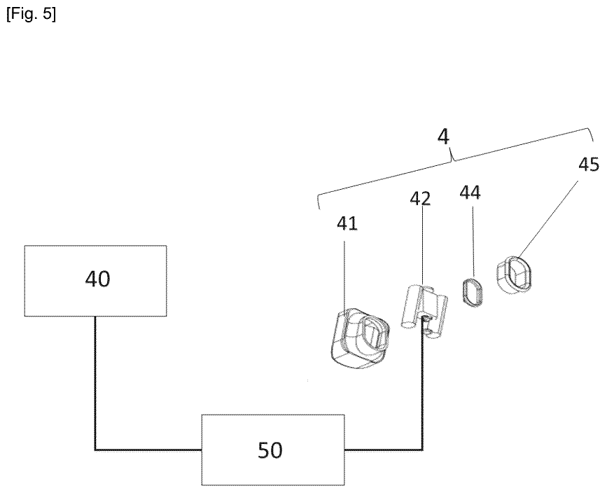

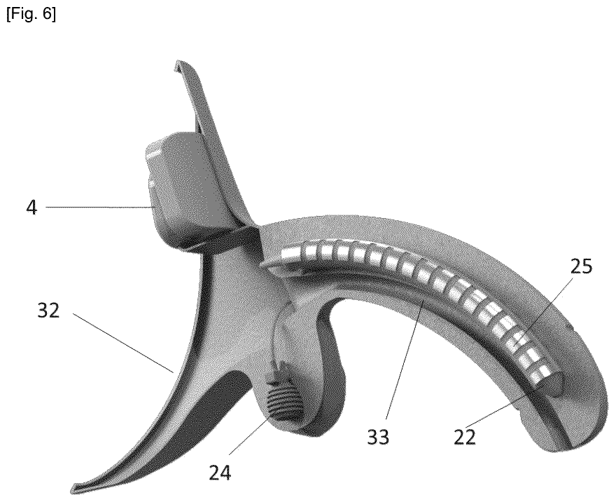

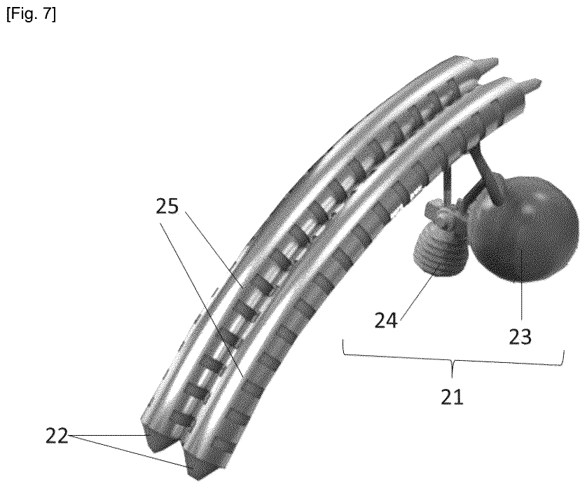

With reference to FIGS. 1 to 7, the penile prosthesis according to the invention, comprising a body (1) forming a phallic-shaped structure capable of simulating the male genital organ, and configured to be placed in contact with a user's pubis by a contact module 3, and furthermore comprising a clitoral stimulation module 4 connected to means for detecting movement 40 and processing means 50.

The prosthesis according to the invention furthermore comprises a contact module 3 arranged on one end of the body 1, and configured to attach to and cover the user's genital organ.

The contact module 3 furthermore comprises a contact surface 31 configured to be placed in contact with the user's pubic region, thereby allowing the prosthesis to be locked in its position of use over the user's genital organ, thus allowing the device to be positioned correctly over the user's pubic region, which will be attached by selected holding means.

According to a first embodiment of the invention, the contact module 3 comprises holding means configured to hold said prosthesis in place in the position of use on the user.

By way of a non-restrictive example, the holding means belong to the group formed by a harness, belt or the like, adhesive material for prosthesis.

According to an alternative embodiment of the invention, the contact surface 31 of the contact module 3 is capable of receiving adhesive means of the prosthesis glue type capable of semi-permanently attaching said prosthesis to the user.

According to a second alternative embodiment of the invention, the prosthesis is held in place by a reinforcing undergarment comprising an orifice capable of receiving the erectile module 2 of the prosthesis according to the invention and allowing the contact module 3 to be held in place against the user's pubis.

Advantageously, this allows the device to be “locked” on to the wearer's pubis, thereby enabling continuous stimulation of the clitoris without the stimulation module's moving outside the erogenous zone to be stimulated.

The prosthesis according to the invention furthermore comprises a clitoral stimulation module 4 arranged in a selected position on the contact module 3, capable of being placed in contact with the user's clitoris, and configured to perform a selected action enabling stimulation of said clitoris.

In practice, the clitoral stimulation module 4 is removable and designed to be inserted into the fixing means in a selected position on the contact module 3.

The clitoral stimulation module 4 of the contact module 3 furthermore comprises at least one power source electrically connected to an electrically powered motor, said stimulation module 4 furthermore comprising at least one electrical activation/deactivation button, enabling clitoral stimulation of the prosthesis to be activated and deactivated manually by the user.

In practice, the device according to the invention is configured to enable the user to define a maximum intensity threshold for clitoral stimulation by the clitoral stimulation module 4, and within which variations in stimulation intensity are included. In other words, variations in stimulation via the accelerometer will be limited to the intensity ranges selected by the user.

According to one particular embodiment, the activation/deactivation button 43 comprises at least one pre-recorded command configured to allow the user to select the maximum threshold of clitoral stimulation intensity of said device.

By way of a non-restrictive example, the maximum stimulation threshold is selected by a control means belonging to the group formed by: a control button on the prosthesis, remote control, smartphone or the like.

For instance, the intensity may belong to the following groups:
0-33% of maximum intensity;
0-66% of maximum intensity; and
0-100% of maximum intensity.

Surprisingly, the selection of the maximum threshold of clitoral stimulation intensity by the clitoral stimulation module 4 can be adapted according to the wearer's sensitivity in relation to the movements detected by the detection means 40.

Advantageously, the user can configure the stimulation variation thresholds by selecting previously saved speed thresholds, a speed that is adaptable to movement and/or to pressure.

By way of a non-restrictive example, the clitoral stimulation module 4 comprises at least one power source of the rechargeable or non-rechargeable battery or rechargeable electric battery type.

According to one embodiment of the invention, the clitoral stimulation module 4 is configured to apply stimulation of variable and adjustable intensity.

By way of a non-restrictive example, the clitoral stimulation module 4 belongs to the group formed by pulsed air, massage and vibration.

The prosthesis according to the invention furthermore comprises means for detecting movement 40 during use, connected to the clitoral stimulation module 4 via processing means 50, and configured to detect the movements and/or pressure experienced by the prosthesis according to selected parameters.

According to a first embodiment of the invention, the means for detecting movement 40 are of the accelerometer type, configured to measure the acceleration of said prosthesis during to-and-fro movements in use.

By way of a non-restrictive example, the accelerometer connected to the clitoral stimulation module 4 is of the non-servo-controlled type and belongs to the group formed by: piezoelectric detection, piezoresistive detection, strain gauge/extensometry, capacitive detection, inductive detection, optical detection, vibrating beam, surface wave.

Furthermore, the accelerometer is configured to detect movements along one to three orthogonal axes, thereby enabling the acceleration of said prosthesis to be measured in 3 spatial dimensions.

In practice, the acceleration measured only affects clitoral stimulation when the accelerometer detects at least one movement with a frequency or amplitude above a chosen threshold in order to avoid variations during movements unrelated to a sexual act.

According to a second embodiment of the invention, the means for detecting movement 40 are of the on-board pressure sensor type mounted on the body 1, and configured to detect any change in pressure applied to the body 1 of the prosthesis.

In practice, the higher the pressure exerted on the body structure, the greater the intensity of stimulation of the wearer's clitoris, adapted to the maximum stimulation threshold selected by the user via the control button.

According to a third embodiment of the invention, the means for detecting movement 40 are of the on-board pressure sensor type mounted on the body 1 in combination with an accelerometer, configured to measure the acceleration of said prosthesis during to-and-fro movements in use.

By way of a non-restrictive example, the pre-recorded intensity thresholds are 33%, 66% and 100% of the maximum intensity that the stimulation module 4 is capable of producing.

The prosthesis according to the invention also comprises processing means 50 connected to the means for detecting movement 40 and to the clitoral stimulation module 4.

The processing means 50 are configured to vary the clitoral stimulation intensity in proportion to the frequency and/or amplitude of movement of and/or pressure on the prosthesis detected by the means for detecting movement 40.

Stimulation intensity means at least one of the parameters belonging to the group formed by: frequency and/or amplitude of pulsed air/massage/vibration applied, force of pulsed air/massage/vibration applied, frequency and/or amplitude of pulsed air/massage/vibration applied in combination with force of pulsed air/massage/vibration applied.

This combination makes it possible to vary the intensity of the wearer's clitoral stimulation by pulsed air, massage or vibration, depending on the embodiment

In practice, the processing means 50 increase the intensity of clitoral stimulation applied by the clitoral stimulation module 4 to the wearer's female genital organ, with the increase being proportional to the acceleration measured when the accelerometer 50 detects at least one movement with a frequency or amplitude above a chosen threshold.

Alternatively, the processing means 50 increase the intensity of clitoral stimulation applied by the clitoral stimulation module 4 to the wearer's female genital organ, with the increase being proportional to the pressure exerted on the body 1, measured when the means for detecting movement 40 detect at least a pressure with a force above a chosen threshold.

According to a third embodiment of the invention, the processing means 50 increase the intensity of clitoral stimulation applied by the clitoral stimulation module 4 to the wearer's female genital organ, with the increase being proportional to the pressure exerted on the body 1, measured when the means for detecting movement 40 detect at least a pressure with a force above a chosen threshold, and to the pressure exerted on the body 1, measured when the means for detecting movement 40 detect at least a pressure with a force above a chosen threshold.

For instance, the processing means 50 consist of an electronic card connected to an on-board accelerometer (or any other sensor enabling an electrical signal to be sent in relation to movement and/or pressure exerted on the body 1 of the prosthesis according to the invention) to a printed circuit board that manages the intensity of clitoral stimulation.

Advantageously, different speeds and intensities of stimulation can be managed via the means for detecting movement 40, enabling a signal to be transmitted by the processing means 50 to the motor 42 producing the pulsed air, the vibrations or the massage of the clitoris in order to adapt the intensity of this stimulation of the clitoris to the user's overall movement during the movements performed while wearing said prosthesis according to the invention.

According to one embodiment of the invention, the movements recorded by the means for detecting movement 40 can induce a proportional variation in stimulation by the clitoral stimulation module 4 in a linear manner. The intensity gradually increases and decreases in this case with more intense and frequent movements.

According to one embodiment of the invention, the movements recorded by the means for detecting movement 40 can induce a proportional variation in stimulation by the clitoral stimulation module 4 through predefined thresholds.

By way of a non-restrictive example, the thresholds belong to the group formed by: from 1 to 33% of the maximum possible intensity, from 33% to 66%, from 66% to 100% of the maximum possible intensity according to the wearer's preferences and sensitivity.

In practice, these thresholds can be changed manually by the user.

In practice, the intensity of stimulation can be adjusted by manipulating at least one activation/deactivation button 43.

By way of a non-restrictive example, holding down the activation/deactivation button 43 when stimulation is active enables the clitoral stimulation module 4 to be activated/deactivated and/or the stimulation mode to be changed (fixed/variable depending on the processing means 50).

According to an alternative embodiment, at least one additional button for adjusting the stimulation intensity is provided on the prosthesis.

According to one particular embodiment of the invention, the stimulation module 4 comprises a vibrating membrane 44 comprising an annular or approximately annular section forming a clitoral endpiece 45, capable of being applied around the clitoral area and in contact with the base of the erectile module 2, and a membrane forming a partition over the entire internal surface of the annular section, said membrane being configured to be moved back and forth repeatedly by the motor 42 during use, and capable of creating a suction effect on the covered clitoral surface.

According to one embodiment, the annular section or approximately annular section forming a clitoral endpiece 45 is removable from said clitoral stimulation module 4.

In practice, the clitoral endpiece 45 can be of various shapes and sizes, allowing the user to choose the size and shape of the part that will envelop the clitoris.

The size and shape of the clitoris differ widely between individuals, and can vary even more as a result of potential treatments.

As a result, the selected depth of the clitoral endpiece can be adapted to clitorises of greater than average length.

Advantageously, both the arrangement and locking structure of the clitoral stimulation module 4 allow its incorporation in and removal from the prosthesis.

The prosthesis according to the invention also comprises an erectile module 2, capable of moving from a state of rest to a state of erection, and from a state of erection to a state of rest, and comprising a phallic-shaped body 1 made of a selected deformable material.

The erectile module 2 furthermore comprises inflation means 22 arranged along the length of the internal volume of the body 1 and configured to receive at least one selected liquid from pumping means 21, thereby allowing movement from a state of rest to a state of erection when the selected liquid is injected into said inflation means 22, and from a state of erection to a state of rest when the selected liquid is ejected from said inflation means 22 towards the pumping means 21.

In practice, the prosthesis according to the invention also comprises a testicular structure 11 projecting from the base of the erectile module 2, and comprising said pumping means 21, configured to be manually compressed to allow the injection and ejection of a selected liquid between the inflation means 22 and the pumping means 21.

The pumping means 21 of the prosthesis according to the invention comprise a pumping reservoir 23 capable of containing at least one selected liquid, connected on the one hand to an elastic manual pump 24, and on the other hand to the inflation means 22.

According to one particular embodiment of the invention, the inflation means 22 arranged along the length of the internal volume of the body 1 comprise at least two inflatable tubular structures arranged laterally and parallel to each other, and configured to be inflated simultaneously when moving from the state of rest to the state of erection.

By way of a non-restrictive example, the body 1 of the erectile module is of a chosen size.

In practice, the inflation means 22 have an exoskeleton 25 made of a selected material arranged along the entire length of the inflation means 22 and configured to stiffen the erectile module 2 in a state of erection, which maintaining the structure of the body 1 in a state of rest.

By way of a non-restrictive example, the exoskeleton 25 is made of a material selected from the group formed by metal, composite and plastic material.

In practice, the pumping reservoir 23 is configured to eject the liquid contained in the reservoir 23 towards the inflation means 22 when manual compression is applied to said pump 24, expelling the air contained in said pumping means 21 in order to create a vacuum in the inflation means 22, said vacuum allowing the injection of the liquid from the pumping reservoir 23 towards the inflation means 22.

For instance, the selected liquid belongs to the group formed by water or any liquid of similar density.

The elastic manual pump 24 furthermore comprises at least one non-return valve arranged between said pump 24 and the reservoir 23 and the inflation means 22, and configured to maintain the expelled liquid in the inflation means 22 in order to maintain said state of erection.

The valve is furthermore configured to allow the liquid to return from the inflation means 22 to the pumping reservoir 23 when compression is applied to said valve, thereby allowing air to be injected into the manual pump 24, breaking the vacuum created when the inflation liquid is pumped into the inflation means 22.

According to one particular embodiment, the prosthesis according to the invention furthermore comprises a penetrating instrument (also known as a “plug”) on the lower part of the contact module 3, configured to allow vaginal or anal penetration of the wearer of the prosthesis according to the invention, thereby allowing additional stimulation of the wearer.

The contact module 3 furthermore comprises a urine collection cup 32 located between the contact surface 31 and the testicular structure, and capable of collecting the product of urination during use.

The urine collection cup 32 is integrally connected to a urine evacuation duct 33 incorporated in the erectile module 2, and running the length of said erectile module 2 to its distal end, and configured to allow the evacuation of urine from the collection cup 32, and towards the outside of the prosthesis without removal of the prosthesis by the user.

In practice, inflating the inflation means 22 with an exoskeleton 25 allows the prosthesis to move to a state of erection while keeping the urine evacuation duct 33 open, thus allowing the user to urinate without having to remove said prosthesis.

According to one particular embodiment of the invention, the device furthermore comprises an additional module for vaginal and/or anal stimulation of the wearer.

Advantageously, the prosthesis according to the invention is ergonomic, and simultaneously enables stimulation of the wearer's clitoris while giving the user having a female genital organ the impression of penetrating a partner possessing his/her own attributes, thereby simulating realistic sexual stimulation based on penetration by the body 1 of the prosthesis of a second user penetrated by the prosthesis.

In addition, it allows penetration of the wearer's partner, while ensuring that the wearer's stimulation is maintained via an appropriate design (ergonomic and comfortable surface resting on the wearer's pubic region)

The invention thus makes it possible to guarantee clitoral stimulation throughout the sexual act, despite the constraints induced by the movements involved in penetrating the partner, by using a specific harness in combination with the invention's ergonomic and comfortable support surface on the wearer's pubis.

1. A penile prosthesis for the female genital organ, comprising:
a phallic-shaped body (1) made of a chosen material,
a contact module (3) arranged at one end of the body (1), configured to attach to and cover the user's genital organ and having a contact surface (31) configured to be placed in contact with the user's pubic region and allow the prosthesis to be locked in its position of use on the user's genital organ; and
a clitoral stimulation module (4), arranged in a selected position relative to the contact module (3), and configured to perform an action enabling stimulation of the wearer's clitoris;
characterised in that the prosthesis furthermore comprises:
means for detecting movement (40) of said prosthesis during use, connected to the clitoral stimulation module (4), and configured to detect the movements made by the prosthesis according to selected parameters; and
processing means (50), connected to the means for detecting movement and clitoral stimulation module (4), configured to vary the intensity of clitoral stimulation in proportion to the frequency and/or amplitude of movement detected.

2. The penile prosthesis according to claim 1, characterised in that the means for detecting movement (40) belong to the group of the accelerometer type, configured to measure the acceleration of said prosthesis during movement in use, at least one on-board pressure sensor mounted on the body (1) configured to vary the clitoral stimulation in proportion to the pressure exerted on said body (1), of the accelerometer type in combination with at least one on-board pressure sensor mounted on the body (1).

3. The penile prosthesis according to claim 2, characterised in that the accelerometer is of the non-servo-controlled type and belongs to the group formed by: piezoelectric detection, piezoresistive detection, strain gauge/extensometry, capacitive detection, inductive detection, optical detection, vibrating beam, surface wave.

4. The penile prosthesis according to claim 2, characterised in that the accelerometer detects movements along one to three orthogonal axes.

5. The penile prosthesis according to claim 3, characterised in that the processing means (50) are capable of controlling the variation in the intensity of clitoral stimulation applied by the clitoral stimulation module (4) to the wearer's female genital organ, with the variation being proportional to the acceleration measured when the accelerometer (50) detects at least one movement with a frequency and/or amplitude above a chosen threshold.

6. The penile prosthesis according to claim 5, characterised in that the clitoral stimulation module (4) furthermore comprises:
at least one power source (41);
an electrically powered motor (42);
at least one button for electrically activating/deactivating (43) the stimulation module (4);
a vibrating membrane (44) comprising an annular or approximately annular section forming a clitoral endpiece (45), capable of being applied around the clitoral area and in contact with the base of the erectile module (2), and a membrane forming a partition (45) over the entire internal surface of the annular section, said membrane being configured to be moved back and forth repeatedly by the motor during use, and capable of creating a suction effect on the covered clitoral surface while allowing the transmission of vibrations from the erectile module (2) to said covered clitoral area.

7. The penile prosthesis according to claim 1, characterised in that it furthermore comprises
an erectile module (2), comprising a structure forming the male genital organ and capable of moving from a state of rest to a state of erection, and from a state of erection to a state of rest, and comprising:
the phallic-shaped body (1) made of a selected deformable material;
inflation means (22) arranged along the length of the internal volume of the body (1), configured to receive at least one selected liquid from pumping means (21), and configured to allow the erectile module (2) to move from a so-called state of rest to a state of erection and from a state of erection to a state of rest;
a testicular structure projecting from the base of the erectile module (2), and comprising the pumping means (21);
the pumping means (21) comprising a pumping reservoir (23) adapted to contain at least one selected liquid, connected on the one hand to an elastic manual pump (24), and on the other hand to the inflation means (22), said pumping reservoir (23) being configured to eject the liquid contained in the reservoir towards the inflation means (22) when manual compression is applied to said pump (24); and
the elastic manual pump (24) furthermore comprises at least one non-return valve arranged between said pump (24) and the reservoir, configured to maintain the liquid ejected into the inflation means (22) in the state of erection, said valve being furthermore configured to allow the return of the liquid from the inflation means (22) to the pumping reservoir (23) when compression is applied to said valve.

8. The penile prosthesis according to claim 1, characterised in that the contact module (3) furthermore comprises a urine collection cup capable of collecting the product of urination during use, said cup being integrally connected to a urine evacuation duct (33) incorporated in the erectile module (2), and running the length of said erectile module (2) up to its distal end, and configured to allow the evacuation of urine from the collection cup.

9. The penile prosthesis according to claim 7 characterised in that the inflation means (22) arranged along the length of the internal volume of the body (1) comprise at least two inflatable tubular structures arranged laterally and parallel to each other, and configured to be inflated simultaneously when moving from the state of rest to the state of erection.

10. Penile prosthesis according to claim 7, characterised that that the inflation means (22) have an exoskeleton made of a selected deformable material arranged along the entire length of the inflation means (22) and configured to stiffen the erectile module (2) in a state of erection.

11. The penile prosthesis according to claim 1, characterised in that the lower section of the contact module (3) comprises a penetrating instrument configured to allow vaginal or anal penetration of the wearer.
